(19) United States
(12) Patent Application Publication
(10) Pub. No.: US 2006/0267939 A1
(43) Pub. Date: Nov. 30, 2006

(54) Mouse structure for receiving a picture

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/135,503

(22) Filed: May 24, 2005

(51) Int. Cl. G09G 5/08

(52) U.S. Cl. 345/163

(57) ABSTRACT

A mouse structure for receiving a picture is described. The mouse structure has a mouse body and a covering element. The mouse body has a receiving groove. The receiving groove has a volume the same as that of the picture for accommodating the picture. The covering element is disposed on the mouse body via a pivotal, a sliding or a covering method to cover the picture in the receiving groove for viewing. The receiving groove of the mouse body and the covering element are matched with each other for accommodating the picture in the receiving groove. Hence, the mouse structure not only can solve the expressionless design of the prior art, but also provides a view and admire function for user.

### BACKGROUND OF THE INVENTION

1. Field of the Invention

The present invention relates to a mouse structure, and particularly relates to a mouse structure having a receiving groove. The receiving groove is able to accommodate a picture for user to view and admire.

2. Description of the Related Art

Referring to FIG. 1, a perspective view of a mouse structure of the prior art is disclosed. The mouse structure has a mouse body 10a. However, the mouse structure lacks any receiving groove for accommodating a picture or photograph.

### SUMMARY OF THE INVENTION

The present invention provides a mouse structure for receiving a picture. The mouse structure has a mouse body with a receiving groove and a covering element. The receiving groove of the mouse body and the covering element are matched with each other for accommodating a picture in the receiving groove. Hence, the present invention not only can solve the expressionless design of the prior art, but also provides a view and admire function for a user.

One aspect of the invention is a mouse structure for receiving a picture. The mouse structure comprises a mouse and a covering element. The mouse body has a receiving groove. The receiving groove has a volume the same as that of the picture for accommodating the picture. The covering element is disposed on the mouse body to cover the picture in the receiving groove for viewing.

Another aspect of the invention is a mouse structure for receiving a picture. The mouse structure comprises a mouse body, a covering element, an auto-opening button, and at least one elastic element. The mouse body has a receiving groove, a hooking hole and a first pivot portion. The receiving groove has a volume the same as that of the picture for accommodating the picture. The covering element has a hooking body matching the hooking hole and a second pivot portion corresponding to the first pivot portion. The covering element is opened and closed relative to the receiving groove via the first pivot portion and the second pivot portion connecting pivotally with each other. The auto-opening button is used to push the hooking body for separating the hooking body from the hooking hook. The elastic element is disposed between the first pivot portion and the second pivot portion. The elastic element springs the covering element when the hooking body is separated from the hooking hole.

Another aspect of the invention is a mouse structure for receiving a picture. The mouse structure comprises a mouse body and a covering element. The mouse body has a receiving groove and a first sliding portion. The receiving groove has a volume the same as that of the picture for accommodating the picture. The covering element has a second sliding portion corresponding to the first sliding portion. The covering element is opened and closed relative to the receiving groove via the first sliding portion and the second sliding portion sliding with each other.

Other aspect of the invention is a mouse structure for receiving a picture. The mouse structure comprises a picture-receiving box, a mouse body, an auto-opening button and a plurality of elastic elements. The picture-receiving box has a hooking body and an opening side for accommodating the picture. The mouse body has a receiving groove for accommodating the picture-receiving box and a hooking hole matching the hooking body. The auto-opening button is used to push the hooking body for separating the hooking body from the hooking hook. The elastic elements are disposed between the picture-receiving box and the receiving groove. The elastic elements spring the picture-receiving box for exposing the opening side outside the receiving groove when the hooking body is separated from the hooking hole.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a perspective view of a mouse structure of the prior art;

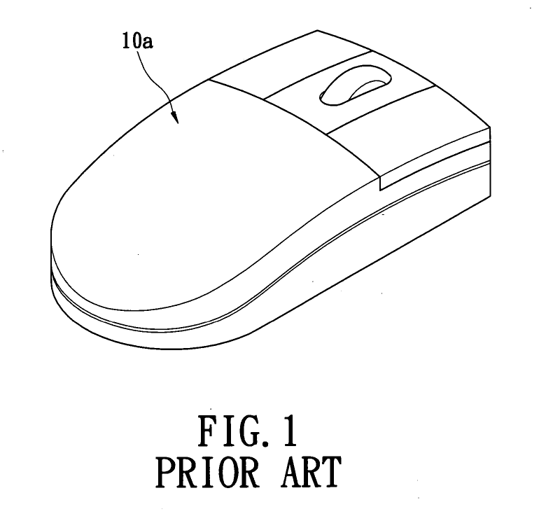

FIG. 2 is an exploded view of a mouse structure for receiving a picture according to the first embodiment of the present invention;

FIG. 3 is an assembled view of a mouse structure for receiving a picture according to the first embodiment of the present invention;

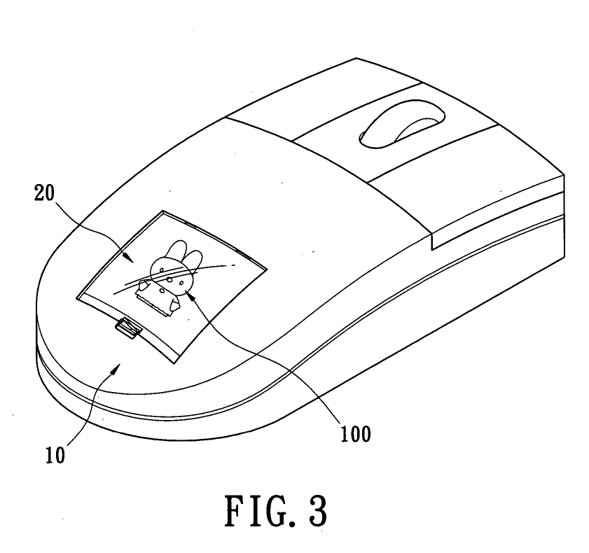

FIG. 4 is an exploded view of a mouse structure for receiving a picture according to the second embodiment of the present invention;

FIG. 5 is an assembled view of a mouse structure for receiving a picture according to the second embodiment of the present invention (a covering element is closed);

FIG. 6 is another assembled view of a mouse structure for receiving a picture according to the second embodiment of the present invention (a covering element is opened);

FIG. 7 is an exploded view of a mouse structure for receiving a picture according to the third embodiment of the present invention;

FIG. 8 is an assembled view of a mouse structure for receiving a picture according to the third embodiment of the present invention (a covering element is closed);

FIG. 9 is another assembled view of a mouse structure for receiving a picture according to the third embodiment of the present invention (a covering element is opened);

FIG. 10 is an exploded view of a mouse structure for receiving a picture according to the fourth embodiment of the present invention;

FIG. 11 is an assembled view of a mouse structure for receiving a picture according to the fourth embodiment of the present invention (a covering element is closed); and

FIG. 12 is another assembled view of a mouse structure for receiving a picture according to the fourth embodiment of the present invention (a covering element is opened).

### DETAILED DESCRIPTION OF PREFERRED EMBODIMENTS

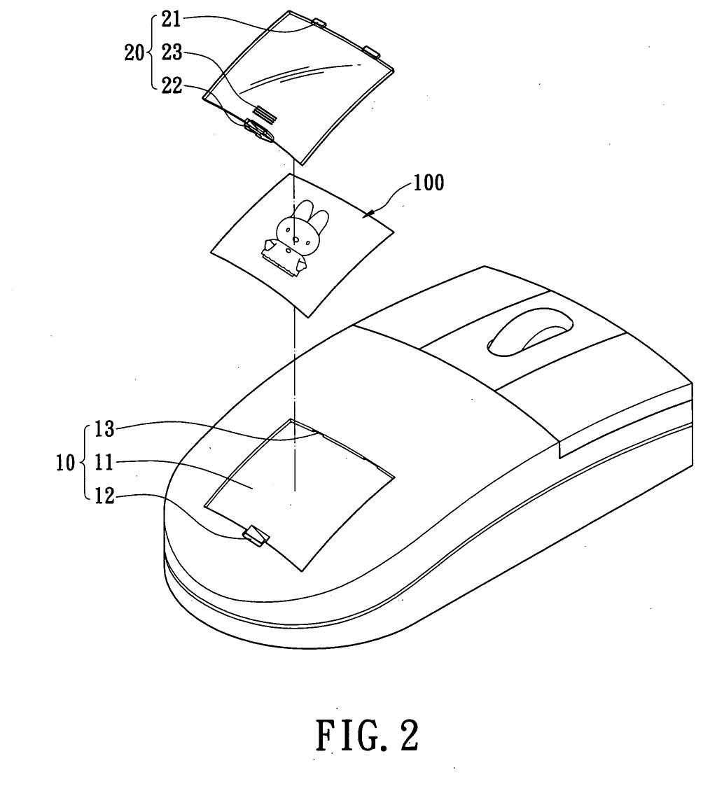

FIGS. 2 arid 3 show an exploded view and an assembled view of a mouse structure for receiving a picture according to the first embodiment of the present invention, respectively. The mouse structure comprises a mouse body 10 and a covering element 20.

The mouse body 10 has a receiving groove 11, a hooking hole 12 and a retaining hole 13. The receiving groove 11 has a volume the same as that of the picture 100 for accommodating the picture 100. The picture can be a photograph or a picture with words, numbers or patterns, and the receiving groove 11 can be formed on a rear edge of the mouse body 10, any place easily viewable by a user, or any place that does not affect the operating function of the mouse structure.

The covering element 20 is disposed on the mouse body 10 to cover the picture 100 in the receiving groove 11 for viewing. The covering element 20 is made of a transparent material for increasing the visibility of the picture. The covering element 20 has a retaining body 21 matching the retaining hole 13, a hooking body 22 matching the hooking hole 12 and a covering body 23 for easily manually lifting the covering element 10.

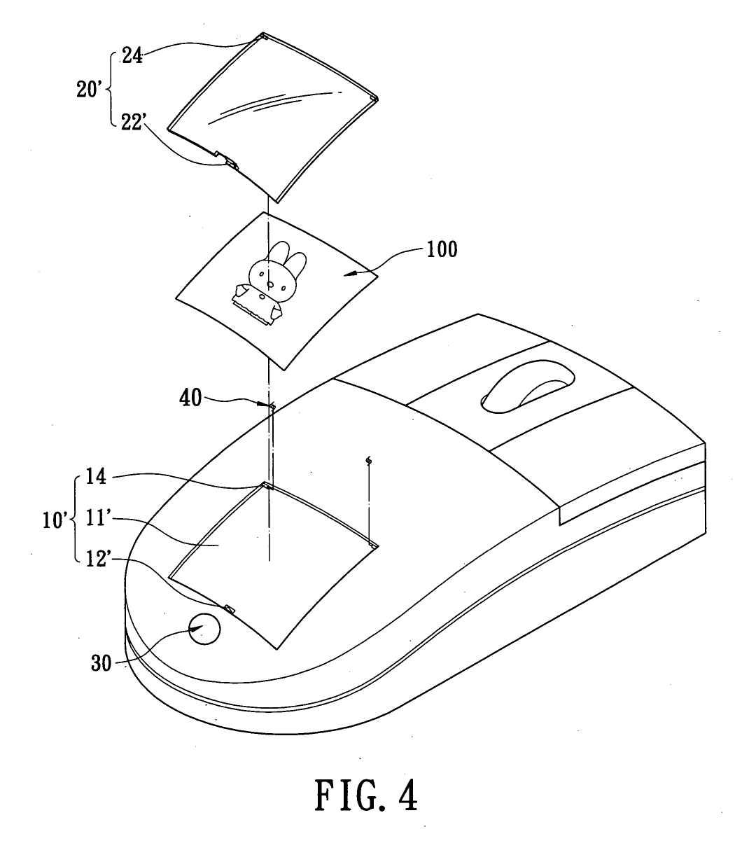

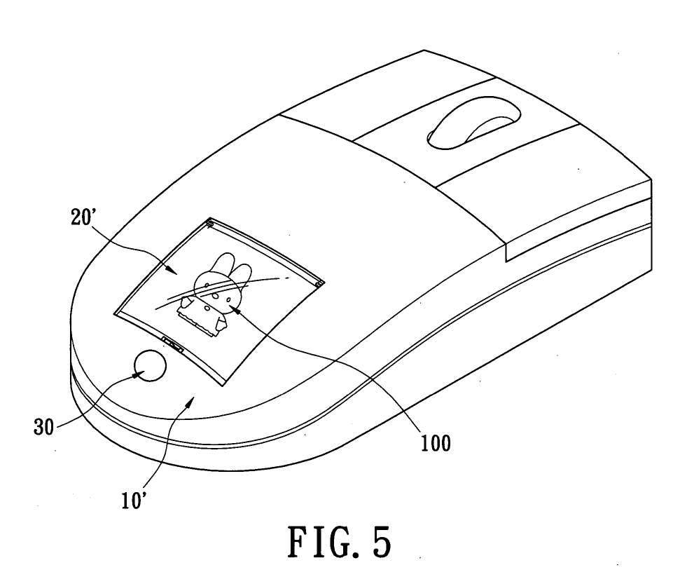

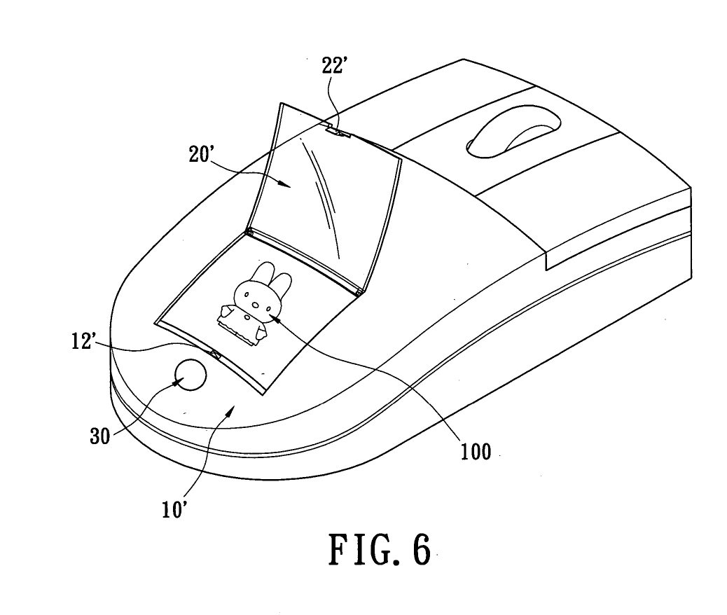

FIGS. 4 to 6 show an exploded view and two assembled views of a mouse structure for receiving a picture according to the second embodiment of the present invention, respectively. The mouse structure comprises a mouse body 10′, a covering element 20′, an auto-opening button 30 and at least one elastic element 40.

The mouse body 10′ has a receiving groove 11′, a hooking hole 12′ and a first pivot portion 14. The receiving groove 11′ has a volume the same as that of the picture 100 for accommodating the picture 100. The covering element 20′ has a hooking body 22′ matching the hooking hole 12′ and a second pivot portion 24 corresponding to the first pivot portion 14. The covering element 20′ is opened and closed relative to the receiving groove 11′ via the first pivot portion 14 and the second pivot portion 24 connecting pivotally with each other.

The auto-opening button 30 is used to push the hooking body 22′ for separating the hooking body, 22′ from the hooking hook 12′. The elastic element 40 is disposed between the first pivot portion 14 and the second pivot portion 24, and the elastic element 40 has one side covering around the first pivot portion 14 or mouse body 10′ and other side contacting a bottom side of the covering element 20′. The elastic element 40 springs the covering element 20′ when the hooking body 22′ is separated from the hooking hole 12′.

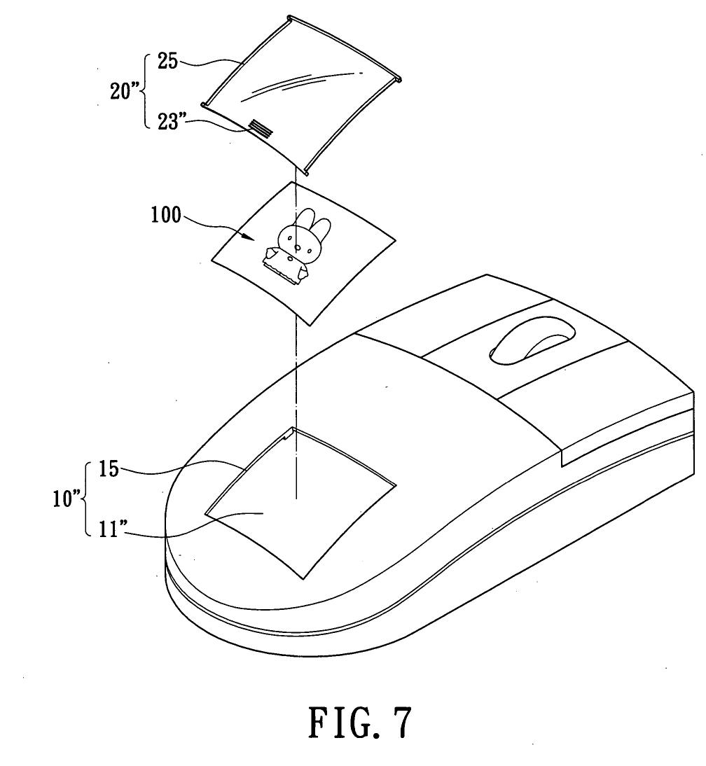

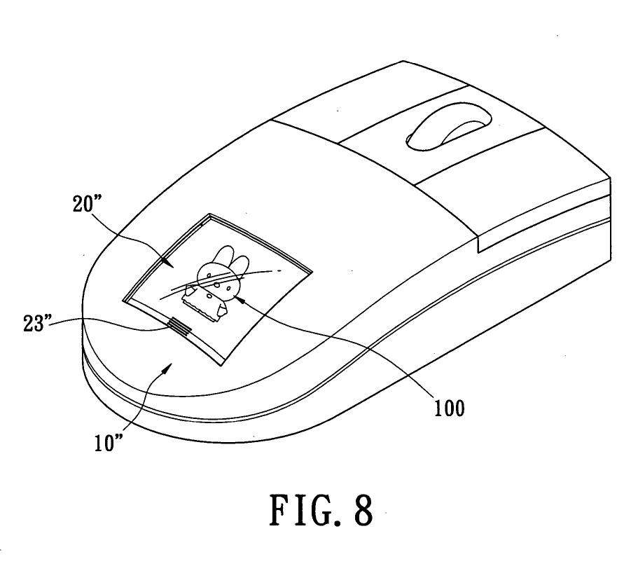

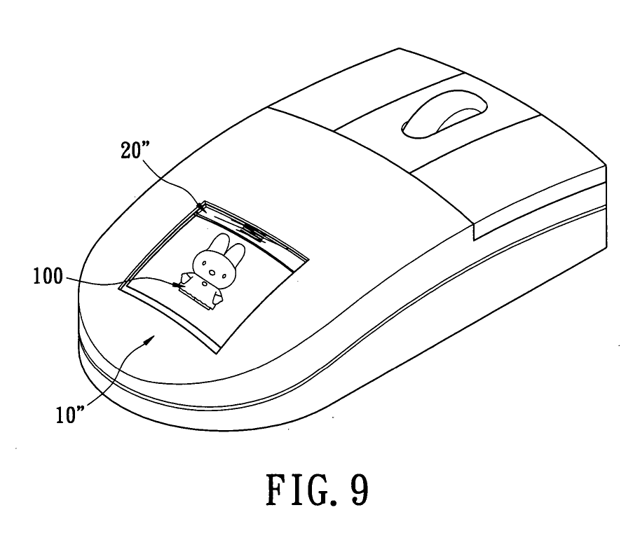

FIGS. 7 to 9 show an exploded view and two assembled views of a mouse structure for receiving a picture according to the third embodiment of the present invention, respectively. The mouse structure comprises a mouse body 10″ and a covering element 20″.

The mouse body 10″ has a receiving groove 11″ and a first sliding portion 15. The receiving groove 11″ has a volume the same as that of the picture 100 for accommodating the picture 100. The covering element 20″ has a second sliding portion 25 corresponding to the first sliding portion 15. The covering element 20″ is opened and closed relative to the receiving groove 11″ via the first sliding portion 15 and the second sliding portion 25 sliding with each other. Moreover, the covering element 20″ has a covering body 23″ for easily manually lifting the covering element 20″.

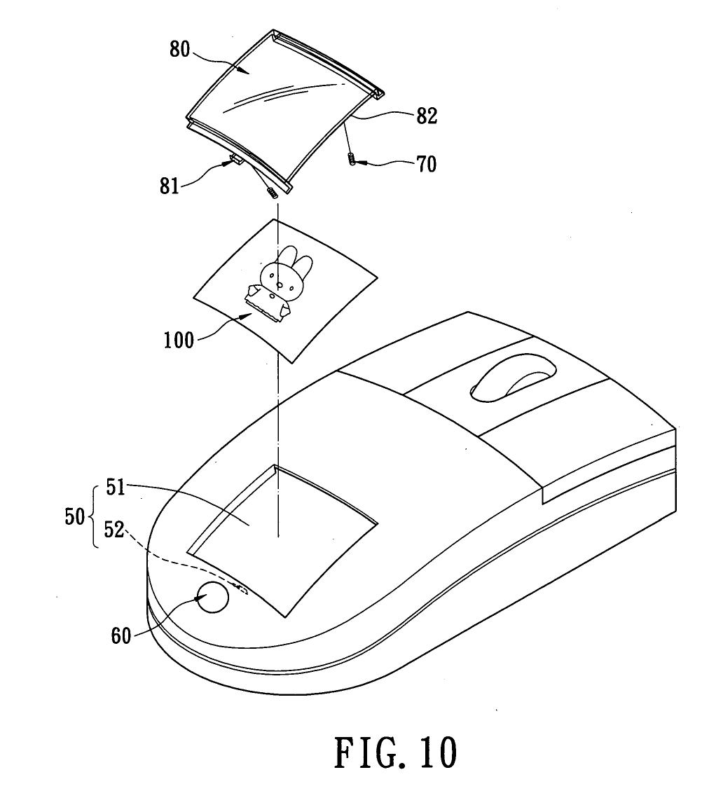

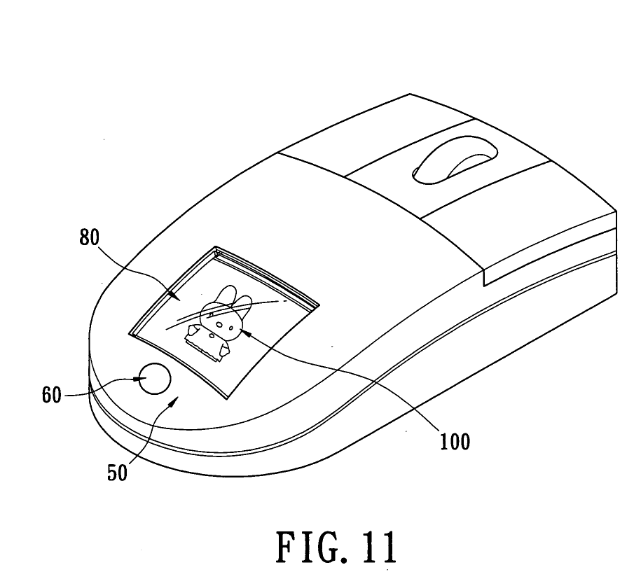

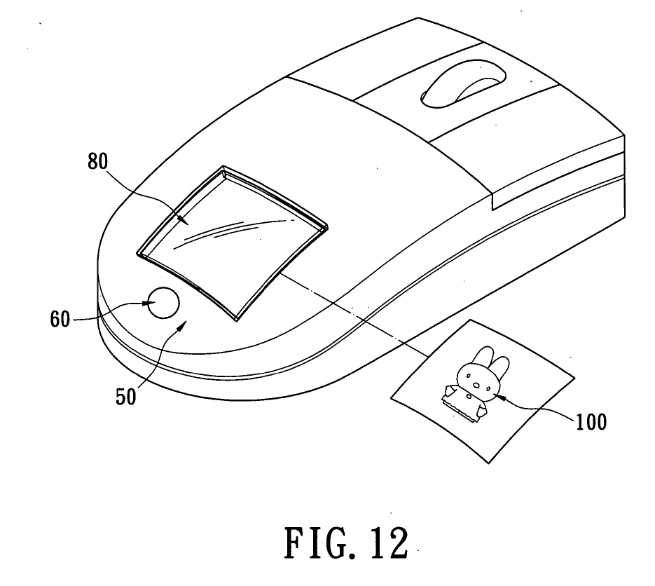

FIGS. 10 to 12 show an exploded view and two assembled views of a mouse structure for receiving a picture according to the fourth embodiment of the present invention, respectively. The mouse structure comprises a mouse body 50, an auto-opening button 60, a plurality of elastic elements 70 and a picture-receiving box 80.

The picture-receiving box 80 has a hooking body 81 and an opening side 82 for accommodating the picture 100. The mouse body 50 has a receiving groove 51 for accommodating the picture-receiving box 80 and a hooking hole 52 matching the hooking body 81. The auto-opening button 60 is used to push the hooking body 81 for separating the hooking body 81 from the hooking hook 52. The elastic elements 70 are disposed between the picture-receiving box 80 and the receiving groove 51. The elastic elements 70 spring the picture-receiving box 80 for exposing the opening side 82 outside the receiving groove 51 when the hooking body 81 is separated from the hooking hole 52. Hence, the exposed opening side 82 is convenient for a user to put the picture 100 into the picture-receiving box 80.

In conclusion, the present invention not only can solve the expressionless design of the prior art, but also provides a view and admire function for user.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mouse structure for receiving a picture, comprising:
a mouse body having a receiving groove, wherein the receiving groove has a volume the same as that of the picture for accommodating the picture; and
a covering element disposed on the mouse body to cover the picture in the receiving groove for viewing.

2. The mouse structure as claimed in claim 1, wherein the picture is a photograph.

3. The mouse structure as claimed in claim 1, wherein the receiving groove is formed on a rear edge of the mouse body.

4. The mouse structure as claimed in claim 1, wherein the covering element is disposed on the mouse body by a pivotal method.

5. The mouse structure as claimed in claim 1, wherein the mouse body has a hooking hole, and the covering element has a hooking body matching the hooking hole.

6. The mouse structure as claimed in claim 5, further comprising an auto-opening button and an elastic element disposed between the mouse body and covering element, wherein the auto-opening button is used to push the hooking body for separating the hooking body from the hooking hook, and the elastic element is disposed between the mouse body and covering element for pushing the hooking body.

7. The mouse structure as claimed in claim 6, wherein the elastic element is a spring.

8. The mouse structure as claimed in claim 1, wherein the covering element is disposed on the mouse body by a sliding method.

9. The mouse structure as claimed in claim 1, wherein the covering element is disposed on the mouse body by a covering method.

10. The mouse structure as claimed in claim 1, wherein the covering element is made of a transparent material.

11. The mouse structure as claimed in claim 1, wherein the covering element has a covering body for manually lifting the covering element.

12. The mouse structure as claimed in claim 1, wherein the mouse body has a retaining hole.

13. The mouse structure as claimed in claim 12, wherein the covering element has a retaining body matching the retaining hole.

14. A mouse structure for receiving a picture, comprising:
a mouse body having a receiving groove, a hooking hole and a first pivot portion, wherein the receiving groove has a volume the same as that of the picture for accommodating the picture;
a covering element having a hooking body matching the hooking hole and a second pivot portion corresponding to the first pivot portion, wherein the covering element is opened and closed relative to the receiving groove via the first pivot portion and the second pivot portion connecting pivotally with each other;
an auto-opening button for pushing the hooking body to separate the hooking body from the hooking hook; and
at least one elastic element disposed between the first pivot portion and the second pivot portion, wherein the elastic element springs the covering element when the hooking body is separated from the hooking hole.

15. The mouse structure as claimed in claim 14, wherein the picture is a photograph.

16. The mouse structure as claimed in claim 14, wherein the receiving groove is formed on a rear edge of the mouse body.

17. The mouse structure as claimed in claim 14, wherein the covering element is made of a transparent material.

18. The mouse structure as claimed in claim 14, wherein the elastic element is a spring.

19. A mouse structure for receiving a picture, comprising:
a mouse body having a receiving groove and a first sliding portion, wherein the receiving groove has a volume the same as that of the picture for accommodating the picture; and
a covering element having a second sliding portion corresponding to the first sliding portion, wherein the covering element is opened and closed relative to the receiving groove via the first sliding portion and the second sliding portion sliding with each other.

20. The mouse structure as claimed in claim 19, wherein the picture is a photograph.

21. The mouse structure as claimed in claim 19, wherein the receiving groove is formed on a rear edge of the mouse body.

22. The mouse structure as claimed in claim 19, wherein the covering element is made of a transparent material.

23. The mouse structure as claimed in claim 19, wherein the covering element has a covering body for manually lifting the covering element.

24. A mouse structure for receiving a picture, comprising:
a picture-receiving box having a hooking body and an opening side for accommodating the picture;
a mouse body having a receiving groove for accommodating the picture-receiving box and a hooking hole matching the hooking body;
an auto-opening button for pushing the hooking body to separate the hooking body from the hooking hook; and
a plurality of elastic elements disposed between the picture-receiving box and the receiving groove, wherein the elastic elements spring the picture-receiving box for exposing the opening side outside the receiving groove when the hooking body is separated from the hooking hole.

25. The mouse structure as claimed in claim 24, wherein the picture is a photograph.

26. The mouse structure as claimed in claim 24, wherein the receiving groove is formed on a rear edge of the mouse body.

27. The mouse structure as claimed in claim 24, wherein the picture-receiving box is made of a transparent material.

28. The mouse structure as claimed in claim 24, wherein the elastic element is a spring.
